(19) United States
(12) Patent Application Publication
(10) Pub. No.: US 2023/0200473 A1
(43) Pub. Date: Jun. 29, 2023

(54) Glove with Raised Grooves

(71) Applicant: Ellen Lima, Chula Vista, CA (US)

(72) Inventor: Ellen Lima, Chula Vista, CA (US)

(21) Appl. No.: 18/058,056

(22) Filed: Nov. 22, 2022

Related U.S. Application Data
(60) Provisional application No. 63/294,447, filed on Dec. 29, 2021.

(51) Int. Cl. A41D 19/015; A01K 15/02

(52) U.S. Cl. CPC A41D 19/01594; A01K 15/02

(57) ABSTRACT

A protective glove is disclosed comprising a rubber sheet having an outer surface and inner surface, the outer surface has a front portion and a back portion, the front portion comprises a plurality of raised surfaces and the inner surface comprises cloth liner. The plurality of raised surfaces is of different shapes in order to hold food for a pet forming a plurality of grooves. The grooves may be of various shapes including polygon, cross shapes, bone shapes. The protective glove proves site to hold soft foods within the grooves which may be continuously rewarded to a pet or dog during training, entertainment, and distracting the pet and at the same time protects the handler's hand during accidental bite by the pet or dog.

### CROSS-REFERENCE TO RELATED APPLICATION

This disclosure claims the benefit of the priority of U.S. Provisional Patent Application No. 63/294,447, entitled “Rubber Glove With Raised Grooves” and filed on Dec. 29, 2021. The above-identified application is incorporated herein by reference in its entirety.

### FIELD OF THE INVENTION

The present invention generally relates to a protective glove. More specifically, it relates to a glove with raised surfaces having grooves to hold food.

### BACKGROUND

Animals are expressive and may communicate their needs by biting, screaming, and getting restless. Sometimes, animals find pleasure in aggressively chasing and grasping their trainers', owners' or caretakers' hands while playing with the trainers, the owners or the caretakers. Accordingly, the pleasure enjoyed by both the animals, and the trainers, the owners or the caretakers may quickly be lost in the event when the animals accidentally bite or scratch the trainer's, the owner's hand. In order to protect hand from accidental bite by an animal/dog, several types of gloves are used during animal handling or training thereof.

Basic obedience training tasks for dogs, include walking on a leash, attention, housebreaking, nonaggression, and socialization with humans or other pets. Dogs are also trained for many other activities, such as dog sports, service dogs, and working dog tasks. Hand feeding is an incredible way of making dog training fast, effective and fun for both dog and trainer/handler. However, during feeding, dog may accidentally bite trainer hand. Therefore, there is a need to provide a glove that may provide constant availability of food as well as hand protection during dog training.

The references to and descriptions of past plans or products made above are not intended to be, and should not be interpreted as, claims or confessions of widespread general knowledge in the art. The preceding prior art discussion, in particular, does not pertain to what is frequently or well known by a person versed in the art, but rather aids in the comprehension of the inventive step of the present invention, of which the identification of appropriate previous art proposals is just one element

### SUMMARY OF THE INVENTION

Present invention discloses a glove for pet training including dog. One object is to provide a glove with raised grooves on which food is put on in order to train, entertain, and distract your dog.

Another object is to provide a glove with raised grooves that allows handlers to always have a reward for their dog without having the dog bite the handler's hand.

Another object is to provide a glove with raised grooves that will facilitate dogs being still while grooming.

Another object is to provide a glove with raised grooves that will allow dog owners to keep dogs distracted from loud noises such as fireworks.

Another object is to provide a glove with raised grooves that dog trainers can use it to efficiently train dogs by constantly having a reward available.

Another object is to provide a glove with raised grooves that can be used to protect fingers from bites when giving dog treats.

Another object is to provide a glove with raised grooves that can be used to protect hands while holding a leash.

Present invention discloses a protective glove comprising a rubber sheet having an outer surface and inner surface, the outer surface has a front portion and a back portion, wherein the front portion comprises a plurality of raised surfaces and the inner surface comprises cloth liner.

In another embodiment the glove may be made up of nylon material. In the embodiments, the plurality of raised surfaces is of different shapes in order to hold food for a pet. The various embodiments may comprise various shapes of raised surfaces with grooves including polygon, cross shapes, bone shapes. The grooves of the raised surfaces provides housing for the food for quick access to a treat. In one of the embodiment, the food may be soft foods including peanut butter or wet dog food.

In an embodiment, the raised surfaces may be available on entire outer surfaces including front and back surfaces. In another embodiment, the raised surfaces may only be present on the front side of the glove on palm, fingers or both. In the embodiment, soft foods may be put on the raised surfaces and the grooves present on therein house the soft foods which may be continuously rewarded to a pet or dog during training, entertainment, and distracting the pet.

In one of the embodiments, the glove has no raised surface at the hand joints for optimum mobility of the hand. In another embodiment, the cuff of the glove is of elastic material.

In an embodiment of the present invention, the raised surfaces are made of food grade silicon material which are press vulcanized to adhere to glove's coating.

It is briefly noted that upon a reading this disclosure, those skilled in the art will recognize various means for carrying out these intended features of the invention. As such it is to be understood that other methods and applications may be adapted to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates prospective view of a glove and raised surfaces in accordance with the embodiments of the present invention disclosed herein;

FIG. 1B illustrates side prospective view of a glove with raised surfaces in accordance with the embodiments of the present invention disclosed herein;

FIG. 1C illustrates prospective view of a glove with raised surfaces in accordance with the embodiments of the present invention disclosed herein;

FIG. 1D illustrates prospective view of a glove with raised surfaces of different shapes in accordance with the embodiments of the present invention disclosed herein;

FIG. 1E illustrates prospective back view of a glove in accordance with the embodiments of the present invention disclosed herein;

FIG. 2 illustrates prospective view of a glove with cuffs in accordance with the embodiments of the present invention disclosed herein;

Other aspects of the present invention shall be more readily understood when considered in conjunction with the accompanying drawings, and the following detailed description, neither of which should be considered limiting.

### DETAILED DESCRIPTION OF INVENTION

The following description includes the preferred best mode of one of the embodiments of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

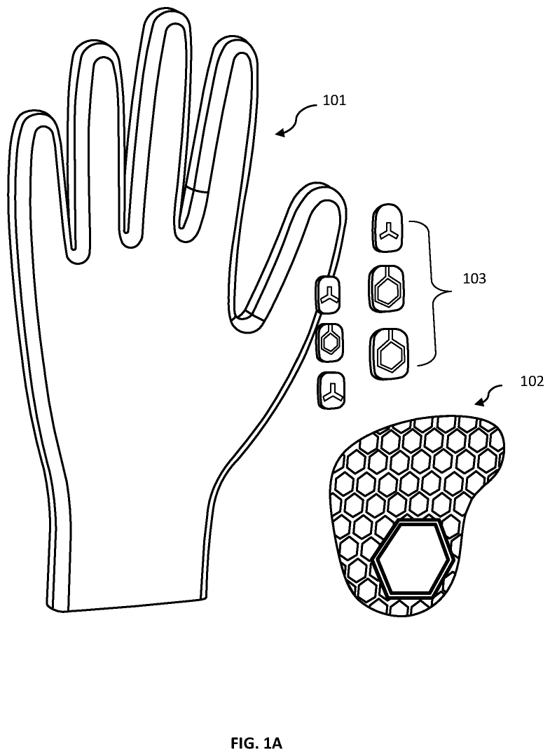

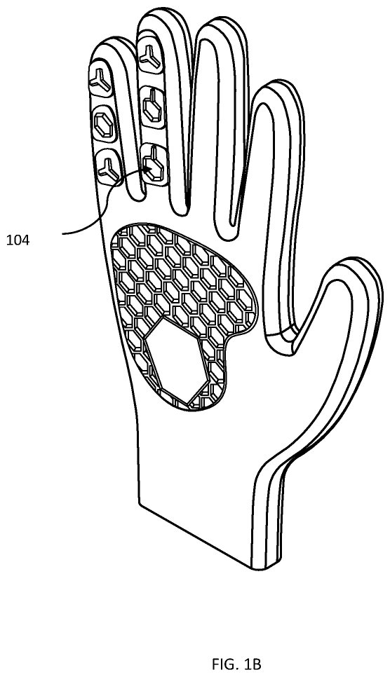

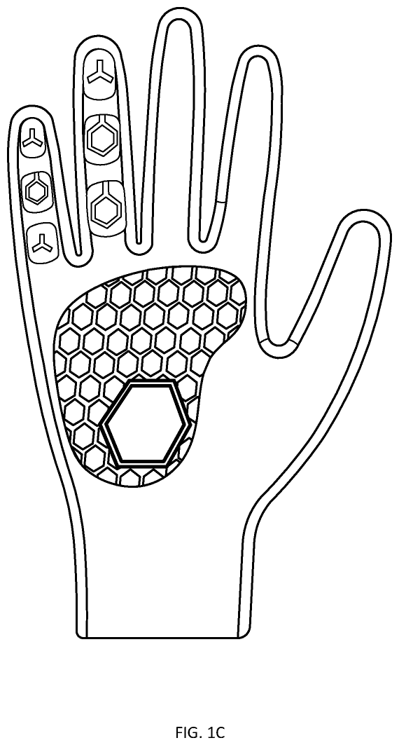

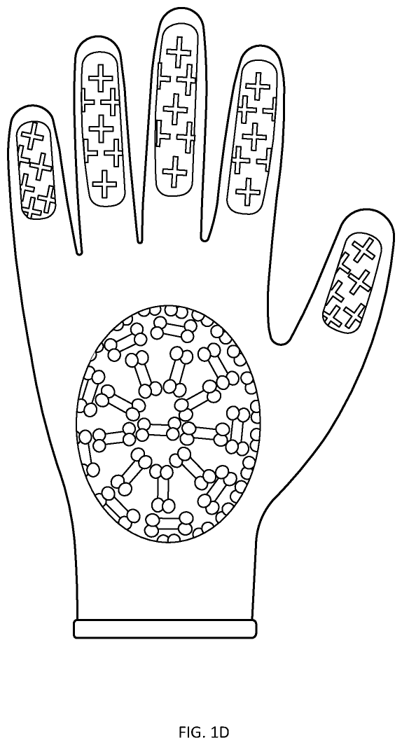

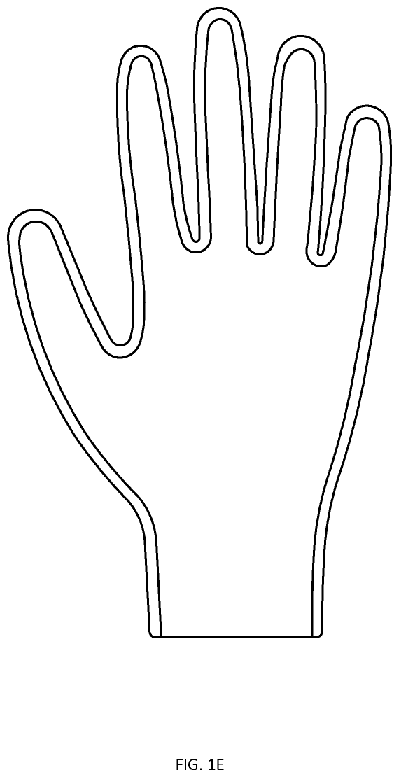

In reference to FIG. 1A, present invention discloses a protective glove 101 comprising a rubber sheet having an outer surface and inner surface, the outer surface has a front portion and a back portion, wherein the front portion comprises a plurality of raised surfaces 102, 103 and the inner surface comprises cloth liner. In one of the embodiments, the protective glove is made of nylon material. In the embodiments the plurality of raised surfaces has grooves that hold food for the pet to be trained preferably a dog.

FIG. 1B-1D shows various shapes of the raised surfaces. In particular, FIG. 1B shows side prospective view of the protective glove 101 which shows grooves 104 in the raised surfaces 102, 103. FIG. 1C, is front view of the protective glove. FIG. 1D is one of the embodiments of the protective glove where different shapes of the raised surfaces are shown comprising bone shape raised surfaces on palm area and cross raised surfaces on finger area. In reference to FIG. 1E, a protective glove from back side is shown.

The various embodiments may comprise various shapes of raised surfaces with grooves including polygon, cross shapes, bone shapes. The grooves of the raised surfaces provide housing for the food for quick access to a treat. In one of the embodiment, the food may be soft foods including peanut butter or wet dog food.

In an embodiment, the raised surfaces may be available on entire outer surfaces including front and back surfaces. In another embodiment, the raised surfaces may only be present on the front side of the glove on palm, fingers or both. In the embodiment, soft foods may be put on the raised surfaces and the grooves present on therein house the soft foods which may be continuously rewarded to a pet or dog during training, entertainment, and distracting the pet.

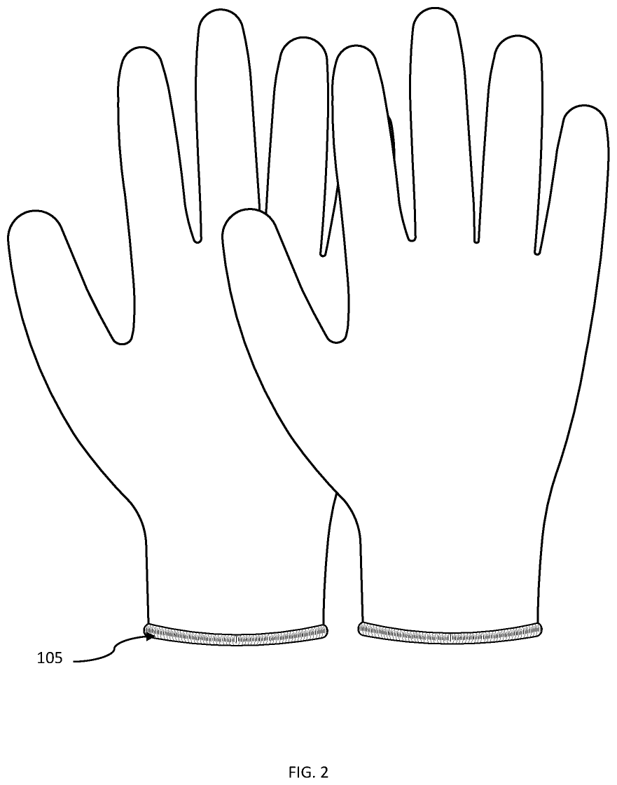

FIG. 2 shows a protective glove 101 wherein a cuff of the glove is shown which is made up of elastic material. In an embodiment of the present invention, the raised surfaces are made of food grade silicon material which are press vulcanized to adhere to glove's coating.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A protective glove for pet training and play, the glove comprising:
a rubber sheet comprises an outer surface and inner surface;
the outer surface has a front portion and a back portion;
the front portion comprises a plurality of raised surface, and
the inner surface comprises cloth liner,
wherein the raised surfaces form grooves to hold food.

2. The glove as claimed in claim 1, wherein the plurality of raised surfaces is of different shapes in order to hold food for a pet.

3. The glove as claimed in claim 1, wherein the grooves of the raised surfaces house food for quick access to a treat.

4. The glove as claimed in claim 3, wherein the housing of the raised surface is meant to hold soft foods including peanut butter or wet dog food.

5. The glove as claimed in claim 1, wherein the raised grooves are present at least on one outer surface.

6. The glove as claimed in claim 1, wherein the raised grooves are present on both the surfaces including front and back portion.

7. The glove as claimed in claim 1, wherein the front portion comprise palm and fingers.

8. The glove as claimed in claim 1, wherein food spreads on the raised grooves in order to train, entertain, and distract the pet.

9. The glove as claimed in claim 6, wherein the glove protects the hand of a handler from dog bite during dog training while allowing hander to constantly reward the dog during the training.

10. The glove as claimed in claim 1, wherein the glove has no raised surface at the hand joints for optimum mobility of the hand.

11. The glove as claimed in claim 1, wherein the cuff of the glove is of elastic material.

12. The glove as claimed in claim 1, wherein glove is made of up of nylon or rubber.

13. The glove as claimed in claim 1, wherein the raised surfaces are of variable shapes including polygon, crossed, bone shapes.

14. The glove as claimed in claim 1, wherein the raised surfaces are made of food grade silicon.

15. The glove as claimed in claim 1, wherein the raised surfaces are press vulcanized to adhere to glove's coating.

16. The glove as claimed in claim 1, wherein the pet includes a dog.
